(19) United States
(12) Patent Application Publication
(10) Pub. No.: US 2006/0059880 A1
(43) Pub. Date: Mar. 23, 2006

(54) Unmanned utility vehicle

(76) Inventor: Paul G. Angott, Bloomfield Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/225,855

(22) Filed: Sep. 13, 2005

Related U.S. Application Data
(60) Provisional application No. 60/609,520, filed on Sep. 13, 2004.

(51) Int. Cl. A01D 34/00

(52) U.S. Cl. 56/10.2 A

(57) ABSTRACT

An unmanned utility vehicle (30) for traversing a plot of land is disclosed that includes a carriage (32) having first and second drive wheels (34, 36) for moving over the plot of land, a guidance assembly (44) for guiding the vehicle (30) about the plot, and at least one tool (46) for performing an operation. The vehicle (30) includes first and second electric drive motors (56, 58) operatively connected to the respective drive wheels (34, 36) and at least one electric tool motor (60) engaging the tool (46). A plurality of sonar sensors (94) are supported by said carriage (32) for detecting objects near said utility vehicle (30) such that the utility vehicle (30) is deactivated or slowed in response to detecting the object.

### CROSS REFERENCE TO RELATED APPLICATION

This application claims the benefit of U.S. Provisional Patent Application Ser. Nos. 60/609,520 filed Sep. 13, 2004.

### BACKGROUND OF THE INVENTION

1. Field of the Invention

The subject invention relates to an unmanned utility vehicle for traversing a plot of land having improved safety systems.

2. Description of the Related Art

Various unmanned utility vehicles, such as autonomous lawn mowers, are known to those of ordinary skill in the art and typically include a carriage having a plurality of drive wheels for moving over the plot of land. The drive wheels are driven by an electric motor powered by batteries. The vehicle also includes at least one tool, such as a cutting assembly, supported by the carriage that is powered by an internal combustion engine. In other words, the internal combustion engine is directly engaging and driving the cutting assembly and the electric motors are only driving the drive wheels to propel the vehicle.

One disadvantage of these vehicles is that operation of the internal combustion engines to power the tool is a drain on the internal combustion engine and requires operating the internal combustion engine at various speeds to perform the task. For instance, if the tool is a cutting assembly, the internal combustion engine must operate at different speeds, or revolutions per minute (RPM), in order to cut different thicknesses of grass. The internal combustion engine may operate at lower RPM for thinner grass, but have to operate at higher RPM for thicker grass to prevent stalling of the internal combustion engine. Operating at various RPM uses significantly more gas and also produces different harmonics at each of the different speeds which results in additional noise from the vehicle. Another disadvantage is that if the electrical motors malfunction, the vehicle may continue to operate without the malfunction being detected. When such a malfunction is detected, the complexity of these unmanned systems requires the vehicle to be out of commission for various lengths of time. Further, these systems tend to be quite expensive so additional vehicles are generally not available to continue in place of the malfunctioning vehicle.

Various manned vehicles, such as riding lawn mowers, are known to those of ordinary skill in the art and include the electric drive motors for propelling the vehicle, as well as having electric motors for running the cutting assembly. Since the vehicles are manned, the drive motors must be sufficiently large to accommodate the weight of the operator in addition to the weight of the vehicle. This requires the electric motors to be significantly more powerful and larger to propel the vehicle, which results in heavier vehicles. These heavier vehicles are likely to damage terrain by leaving large ruts or gouges during operation. Another disadvantage is that these electrical motors tend not to be modular, such that if one of the motors malfunctions or breaks, a new motor specific for such operation must be utilized on the vehicle. Said another way, the electrical motors of these manned vehicles generally are not modular.

Mowers fall into the following categories: gas, diesel powered or electric. Electric mowers have a cord, batteries, or are solar powered. Commercial mowers are all powered by gas or diesel with one exception, which is a battery powered greens mower. The greens mower's main selling feature is that it is quiet and golf courses can start cutting the greens earlier, providing more playing time for more revenue. Electric motors are quieter and have less maintenance but their power output is limited. A cord limits where the mower can travel and batteries are heavy and have limited power from a practical standpoint.

The industry does not consider a battery-powered mower that will run over 2 hours cost effective due to the size, weight, and cost of the batteries. The one exception is the greens mower but it has a limited application because greens have relatively small area to cut. A number of companies make battery powered mowers or mowers with cords for the consumer market. Some are self-propelled and others are not.

There are no self-guided, commercial mowers. There are 4 consumer, self-guided mowers that use buried cable and the mower bounces off the perimeter and cuts the grass in a semi-random fashion. Typically, these mowers solar powered or battery powered.

Most all commercial mowers sold have side discharge that typically throws the grass 10-12 feet from the mower. This is the quickest and lowest cost method to cut grass. These mowers travel up to 8 or 10 MPH because 70-90% of the cost of cutting grass is labor and they want to minimize labor. These commercial mowers can throw rocks as large as a baseball up to 200 feet.

### SUMMARY OF THE INVENTION AND ADVANTAGES

The subject invention provides an unmanned utility vehicle for traversing a plot of land having improved safety. The vehicle comprises a carriage having first and second drive wheels for moving over the plot of land and first and second electric drive motors operatively connected to first and second drive wheels. A first drive motor controller is operatively connected to the first electric drive motor and a second drive motor controller is operatively connected to the second electric drive motor. The vehicle also comprises at least one tool supported by the carriage for operation, at least one electric tool motor engaging the tool and supported by the carriage, and a tool motor controller operatively connected to the electric tool motor. A main controller communicates with the drive motor controllers and the tool motor controller to control the electric drive and tool motors. A controller area network interconnects the main controller, the drive motor controllers, and the tool motor controller for facilitating communication therebetween to improve operation and modularity of the vehicle. A plurality of sonar sensors mounted about said carriage for detecting objects and transmitting a signal to said main controller to deactivate or reduce at least one of said electric drive motors and said electric tool motor in response to detecting the object.

The subject invention provides a utility vehicle having improved safety that overcomes the related art vehicles. Specifically, the subject invention provides a small, lightweight, and energy efficient vehicle.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a top perspective view of an unmanned utility vehicle according to the subject invention;

FIG. 2 is a bottom perspective of the unmanned utility vehicle shown in FIG. 1;

FIG. 3 is a top perspective view of the unmanned utility vehicle shown in FIG. 1 having a cover removed;

FIG. 4A is a top perspective view of one embodiment of a drive assembly, a tool assembly, a lift assembly, and a power supply of the unmanned utility vehicle;

FIG. 4B is a top perspective view of another embodiment of a drive assembly, a tool assembly, a lift assembly, and a power supply of the unmanned utility vehicle;

FIG. 5 is a schematic flowchart of the unmanned utility vehicle;

FIG. 6 is a side view of the drive assembly;

FIG. 7 is a cross-sectional view taken along Line 7-7 shown in FIG. 6;

FIG. 8 is an exploded view of the drive assembly shown in FIG. 6;

FIG. 9 is an exploded view of a drive motor housing including a drive motor and a drive motor controller;

FIG. 10 is a cross-sectional view of the drive motor shown in FIG. 9;

FIG. 11 is an exploded view of the drive motor shown in FIG. 9;

FIG. 12 is an exploded view of a gear assembly shown in FIG. 9;

FIG. 13 is a side view of the tool assembly;

FIG. 14 is a cross-sectional view of the tool assembly shown in FIG. 13;

FIG. 15 is an exploded view of the tool assembly shown in FIG. 13;

FIG. 16 is an exploded view tool motor housing including a tool motor and a tool motor controller;

FIG. 17 is an exploded view of the tool motor shown in FIG. 16;

FIG. 18 is an exploded view of the lift assembly including a lift mechanism and a lift motor housing;

FIG. 19 is an exploded view of the lift mechanism shown in FIG. 18;

FIG. 20 is an exploded view of the lift motor housing including a lift motor and a lift motor controller;

FIG. 21 is a partial sectional view of the power supply shown in FIG. 4;

FIG. 22 is an exploded view of a generator;

FIG. 23 is a top perspective view of the unmanned utility vehicle having a user interface mounted into the cover; and

FIG. 24 is a perspective view of the utility vehicle and the area about the vehicle that is monitored by sensors.

### DETAILED DESCRIPTION OF THE INVENTION

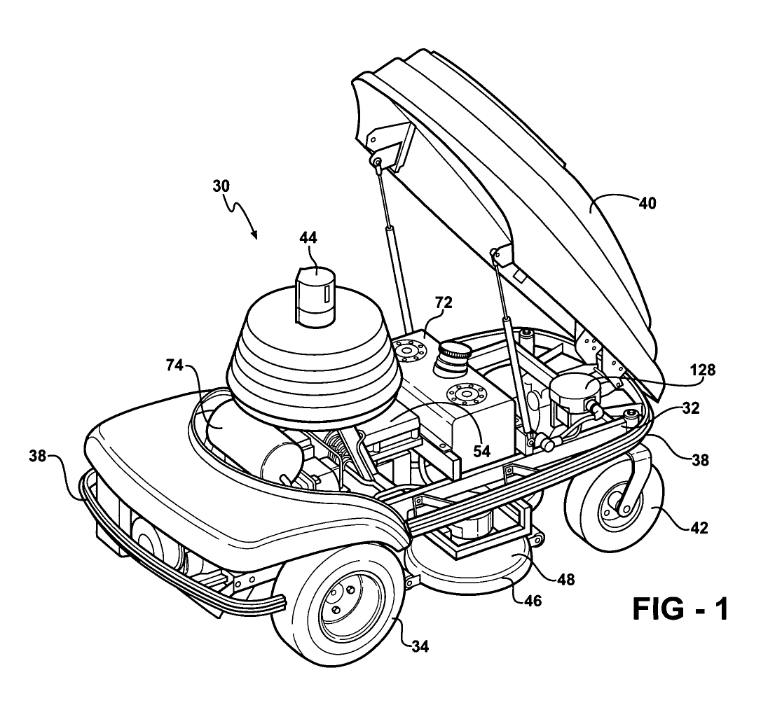

Referring to the Figures, wherein like numerals indicate corresponding parts throughout the several views, an unmanned utility vehicle 30 for traversing a plot of land is shown generally at in FIG. 1. The unmanned utility vehicle 30 may include, but is not limited to, an autonomous lawn mower, vacuum cleaner, sweeper, or scrubber, polisher, sander, or buffer, beach cleaner, ice groomer, or line painter.

The vehicle 30 includes a carriage 32 having first and second drive wheels 34, 36 for moving over the plot of land, a bumper 38, and a cover 40. With reference to FIG. 1, the cover 40 is movable between an open position and a closed position with the cover 40 being shown in the open position. The vehicle 30 may also includes at least one non-drive, or dummy, wheel that is driven by the drive wheels 34, 36. For example, the non-drive wheel 42 may be a caster-type wheel that is capable of swiveling in multiple directions. Alternatively, the vehicle 30 have each of the wheels being driven, i.e., three or more wheels that are driven to improve accuracy.

A guidance assembly 44 is supported by the carriage 32 for guiding the vehicle 30 about the plot. The guidance assembly 44 may be selected from at least one of a laser navigation system, a radio frequency navigation system, a GPS navigation system, and a camera navigation system. The guidance assembly 44 may also include a platform roll pitch controller and a turret rotation controller. However, it is to be appreciated that other guidance assemblies 44 may be employed with the subject invention so long as the vehicle 30 is autonomous or unmanned. Such guidance assemblies 44 are disclosed in U.S. Pat. Nos. 6,556,598 and 6,598,692, which are commonly assigned to assignee of the subject invention and which are incorporated herein by reference. As discussed above, the related art assemblies have additional weight due to an operator having to ride the vehicle 30 and due to the vehicle 30 needing to be sufficiently large to support the operator. Since the subject invention is unmanned, the vehicle 30 has lesser weight and does not need to be as heavy, thereby reducing the amount of damage that may be done during operation. Still another advantage is that the vehicle 30 has reduced fuel consumption as well.

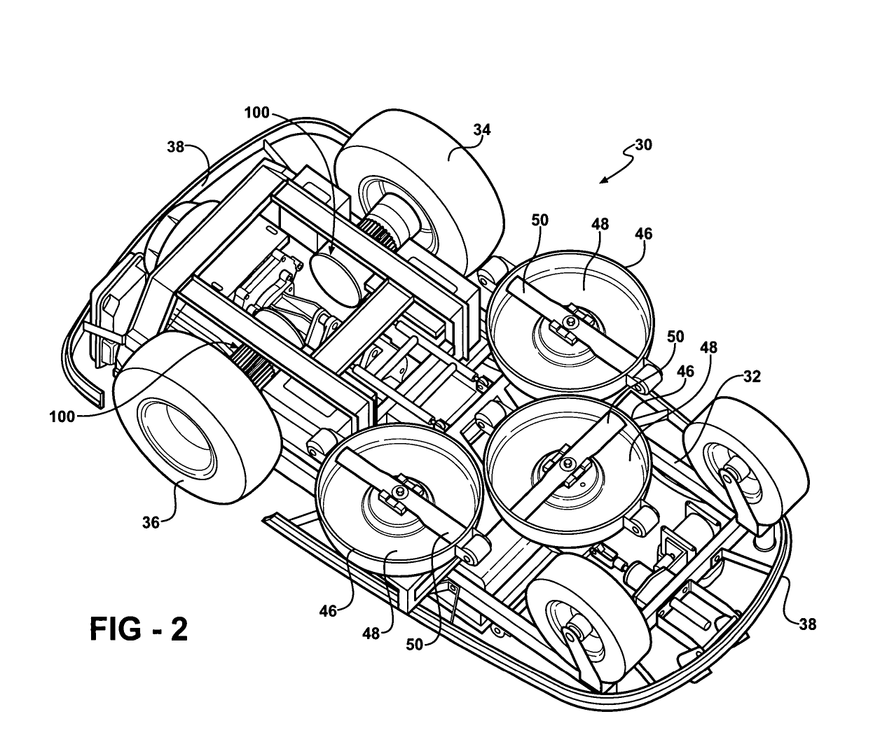

Depending upon the particular type of vehicle 30, the vehicle 30 includes at least one tool 46 supported by the carriage 32 for performing an operation. It is to be appreciated that the tool 46 may be carried by the carriage 32, pulled behind the carriage 32, or pushed in front of the carriage 32. Referring to FIG. 2, the vehicle 30 is illustrated as a lawn mower and the tool 46 is a mower deck having three mower assemblies. The mower deck may have more or fewer decks depending upon a desired width of cut, such as or. The mower assemblies include three individual domes 48 that house a blade 50 for mowing and cutting grass. For clarity, the subject invention will be described for use with a lawn mower without limitation. It is to be appreciated that reference numerals may be used in connection with the same component even though the identifier is different, i.e., both the vehicle 30 and lawn mower may be numeral and the tool 46 and mower deck are both numeral. However, the tool 46 may be selected from at least one of a mower assembly, a sweeping assembly, a cleaning assembly, and a painting assembly for the particular application. The vehicle 30 may further include an electric lift motor 52 operatively connected to the tool 46 for positioning the tool 46 for use, such as by raising or lowering.

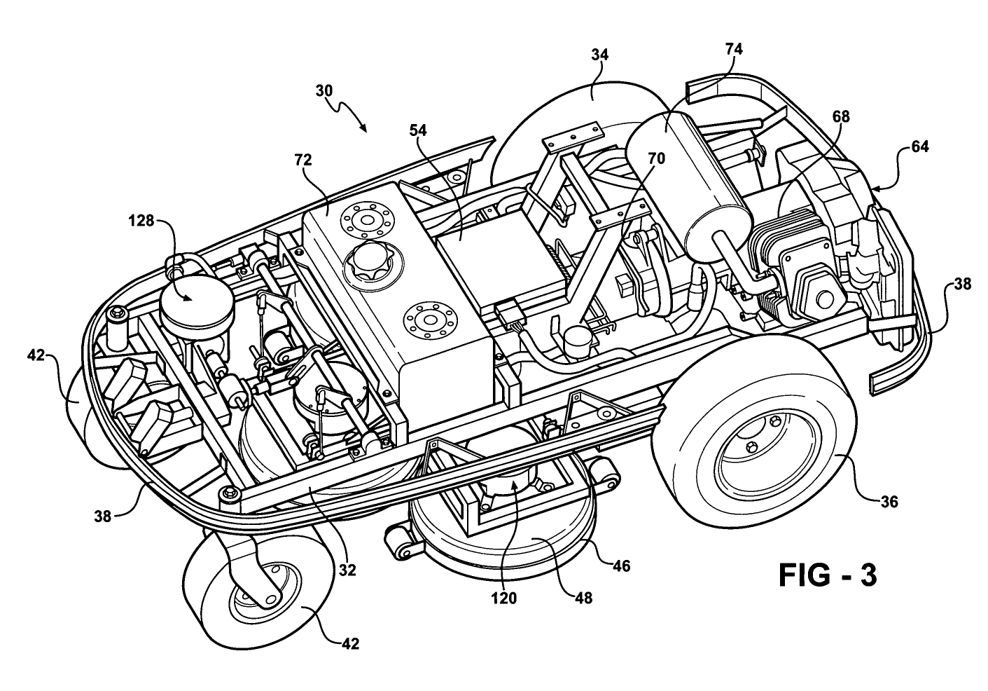

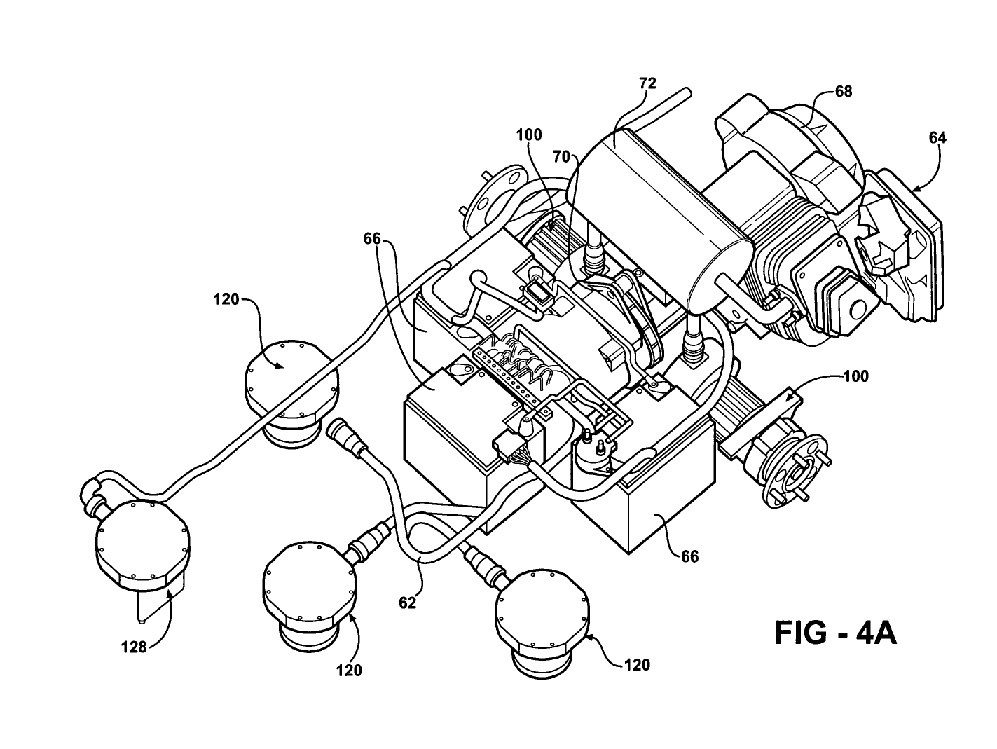

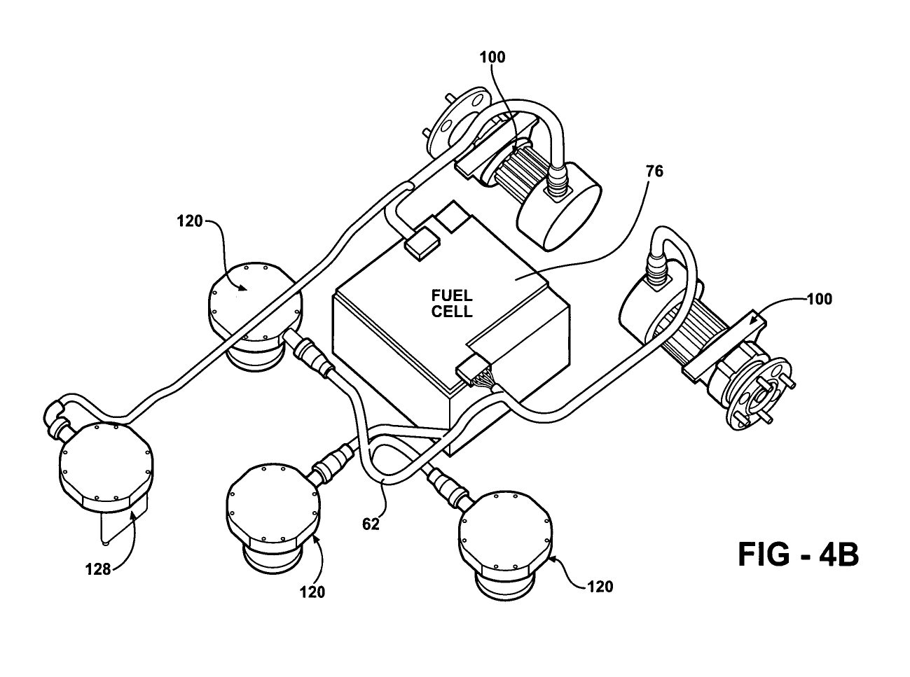

FIG. 3 is a top perspective view of the vehicle 30 having the cover 40 removed. The vehicle 30 includes a main controller 54 for controlling the vehicle 30 as will be described in more detail below. Referring to FIG. 4A, the carriage 32 and cover 40 of the vehicle 30 have been removed to more easily describe the additional components. The vehicle 30 includes a first electric drive motor 56 and a second electric drive motor 58 operatively connected to the first drive wheel 34 and the second drive wheel 36. The vehicle 30 also includes at least one electric tool motor 60 engaging the tool 46 that is also supported by the carriage 32. In FIG. 4A, the vehicle 30 includes three tool motors for driving each of the mower decks. A wiring harness 62 interconnects each of the motors 52, 56, 58, 60 to the main controller 54.

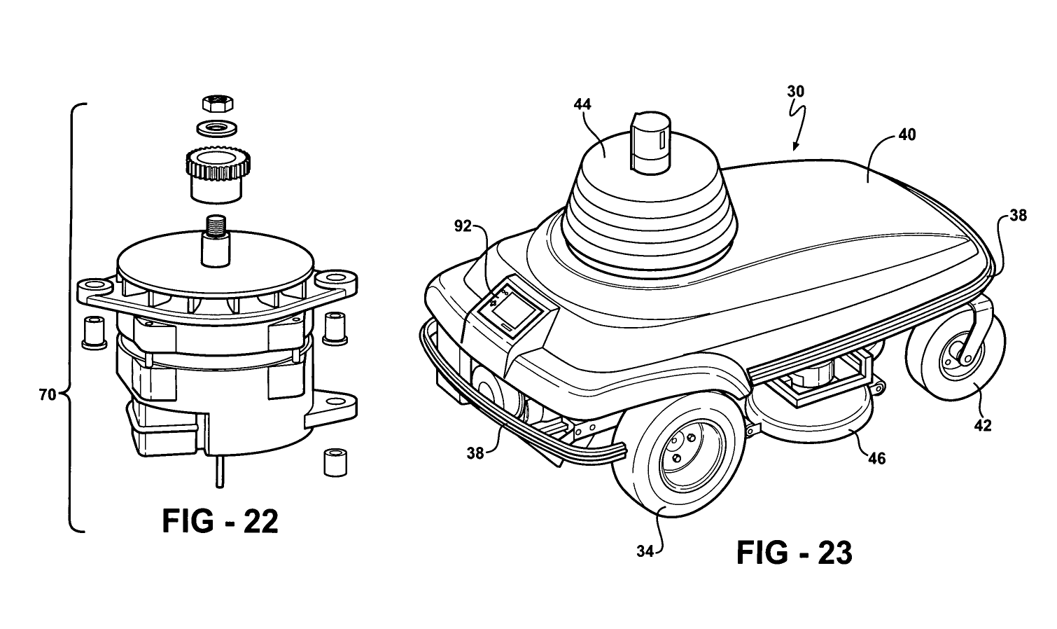

The vehicle 30 further includes a power supply 64 supported by the carriage 32 for powering the electric lift motor 52, the electric drive motors 56, 58, and the electric tool motor 60. In the embodiment shown in FIG. 4A, the power supply 64 comprises a plurality of batteries 66 for running the electric lift motor 52, the electric drive motors 56, 58 and the electric tool motor 60. An internal combustion engine 68 and a generator 70 may be used to charge the batteries 66. An engine controller may be used to monitor the performance of the internal combustion engine 68, the generator 70, and the batteries 66. The batteries 66 may also be used as an electric starter for the internal combustion engine 68. A fuel tank 72 (FIG. 3) stores the fuel for operating the internal combustion engine 68. A side view of the internal combustion engine 68 is shown in FIG. 21. The generator 70 is preferably an alternator and is shown in FIG. 22. Since the internal combustion engine 68 only charges the batteries 66, the internal combustion engine 68 may be operated at a constant revolutions per minute (RPM). One advantage of operating the internal combustion engine 68 at constant RPM is that noise and fuel consumption is reduced. Further, the subject invention includes a muffler 74 connected to the internal combustion engine 68 that muffles a predetermined harmonic. Because the internal combustion engine 68 operates at a nearly constant RPM, the muffler 74 is designed to eliminate the specific harmonic, which results in the vehicle 30 being significantly quieter. Another embodiment of the power supply 64 is illustrated in FIG. 4B. The power supply 64 comprises a fuel cell 76 that powers the electric drive motors 56, 58 and the electric tool motor 60.

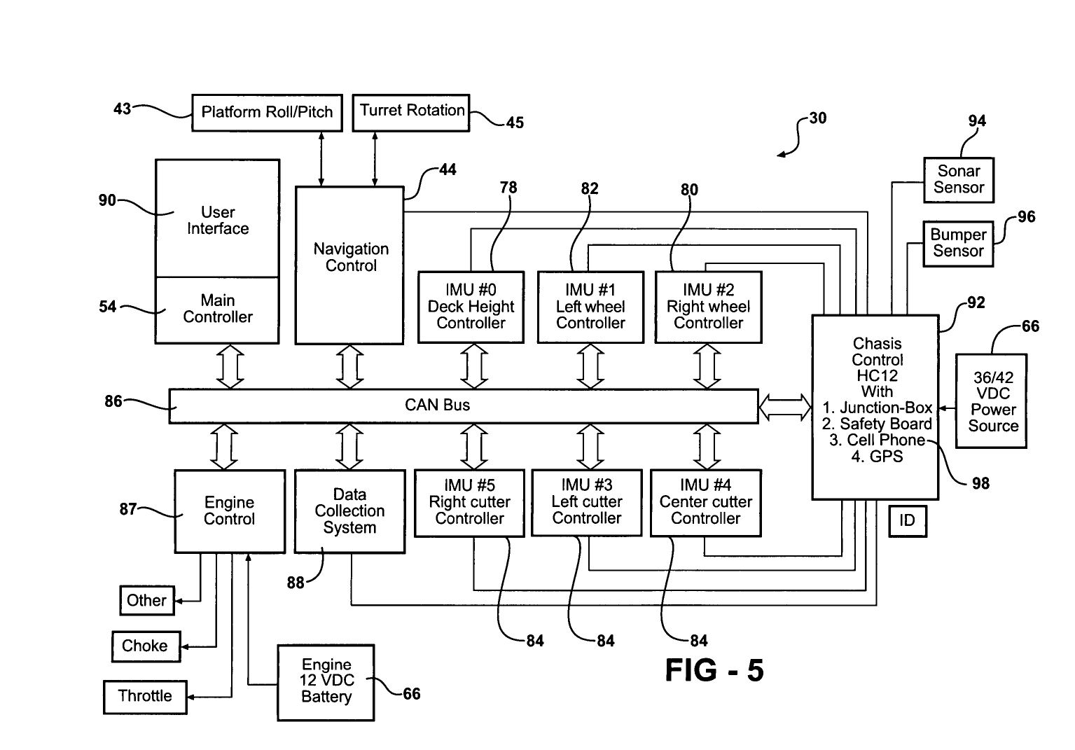

With reference to FIG. 5, a schematic flowchart representing the unmanned utility vehicle 30 is shown. The electric lift motor 52, the electric drive motors 56, 58, and the tool motor 60 are brushless electric motors. Brushless electric motors are typically high endurance and have long run times without requiring maintenance. For example, brushless motors have an operating life of approximately 5,000 to hours whereas the brush-type motors have an operating life of about 1,000 to 1,500 hours. Another advantage of the subject invention is that the vehicle 30 is free of belts and hydraulic units for operating such vehicles 30. The belts are replaced by the electric tool motor 60 and the electric drive motors 56, 58 and the hydraulic unit is replaced by the lift motors 52. The brushless motors 52, 56, 58, 60 are also about 30% lighter than the brush-type motors. This is advantageous because the vehicle 30 is lightweight and will not compact the grass that results in a better cut.

Each of the above motors 52, 56, 58, 60 also includes a motor controller operatively connected thereto. For example, a lift motor controller 78 is operatively connected to the lift motor 52, a first drive motor controller 78, 80 is operatively connected to the first electric drive motor 56, a second drive motor controller 82 is operatively connected to the second electric drive motor 58, and a tool motor controller 84 is operatively connected to the electric tool motor 60. As one example, the controllers may include printed circuit boards having the necessary components to receive signals from the main controller 54 through the wiring harness 62 and then interpret the signal from the main controller 54 and generate and transmit a signal to operate the respective motor.

The main controller 54 communicates with the lift motor controller 78, the drive motor controllers 78, 82, 84 and the tool motor controller 84 to control the lift, electric drive, and tool motors 60. Further, each controller may include a unique identifier to identify the controller and motor to the main controller 54. A controller area network 86, commonly referred to as CAN BUS, interconnects the main controller 54, the drive motor controllers 78, 82, 84, and the tool motor controller 84 for facilitating communication therebetween to improve operation of the vehicle 30. The CAN BUS also communicates with a data collection system 88 for collecting various information relating to each of the motors 52, 56, 58, 60 and a user interfaces 90. A chassis control 92, including a global positioning system receiver, is also in communication with the CAN BUS. Multiple sonar sensors 94 are positioned about the carriage 32 and bumper sensors 96 communicates with the chassis control 92 and with the CAN BUS to provide safety.

In one embodiment, each of the motors 52, 56, 58, 60 may operate using sinusoidal control. To ensure accuracy of the vehicle 30, at least the drive motors 56, 58 should operate using sinusoidal control. The sinusoidal control allows the main controller 54 to precisely control the operation of each of the motors 52, 56, 58, 60. This is particularly advantageous because the movement of the vehicle 30 can be precisely controlled. Another advantage is that the tool motors 60 can be adjusted for varying types and thickness of grass. For example, if the grass is overly thick, then the main controller 54 may operate the tool 46 at a faster RPM, whereas if the grass is a very thin grass, then the tool 46 may operate at a slower speed. The main controller 54 is also able to detect when any one of the tool motors 60 fails. If the tool motor 60 fails, then the main controller 54 recalculates the cutting pattern for the specified area with the remaining tool motors 60. In this manner, the vehicle 30 assembly is still able to complete the cut even if the tool motor 60 fails.

The user interface 90 may be used for programming a route to be followed by the vehicle 30 as best shown in FIG. 23. A remote control (not shown) may also be used to interface with the user interface 90/main controller 54 to program the route into the vehicle 30. The remote control may be a wired module, a wireless module, or both. The user interface 90 may mount into the rear of the cover 40 and may be removable therefrom. Alternatively, the user interface 90 may be permanently formed into the cover 40. The user interface 90 and the main controller 54 may be formed as a single, integral unit removable from the carriage 32. In this manner, the user interface 90 may be used on different vehicles 30, if such vehicles 30 should become inoperable. If multiple vehicles 30 are owned and operated, then the user interface 90 for each one of the vehicles 30 may include relevant information and data about each of the other vehicles 30. For example, the positioning data for achieving various cutting patterns may be stored on each one of the user interfaces 90. If one of the interfaces fails, then any one of the other interfaces may be connected to the vehicles 30 to transfer the information respectively.

The vehicle 30 also includes a communication device 98 supported by the carriage 32 and in communication with the main controller 54 for wirelessly transmitting signals from the vehicle 30 to a base (not shown). The communication device 98 may be used to alert the operator of an error or problem with the vehicle 30. One such communication device 98 is disclosed in copending U.S. patent application Ser. No. 10/179,558 titled “Automatic billing system for a lawn mowing service using GPS”, which is incorporated herein by reference.

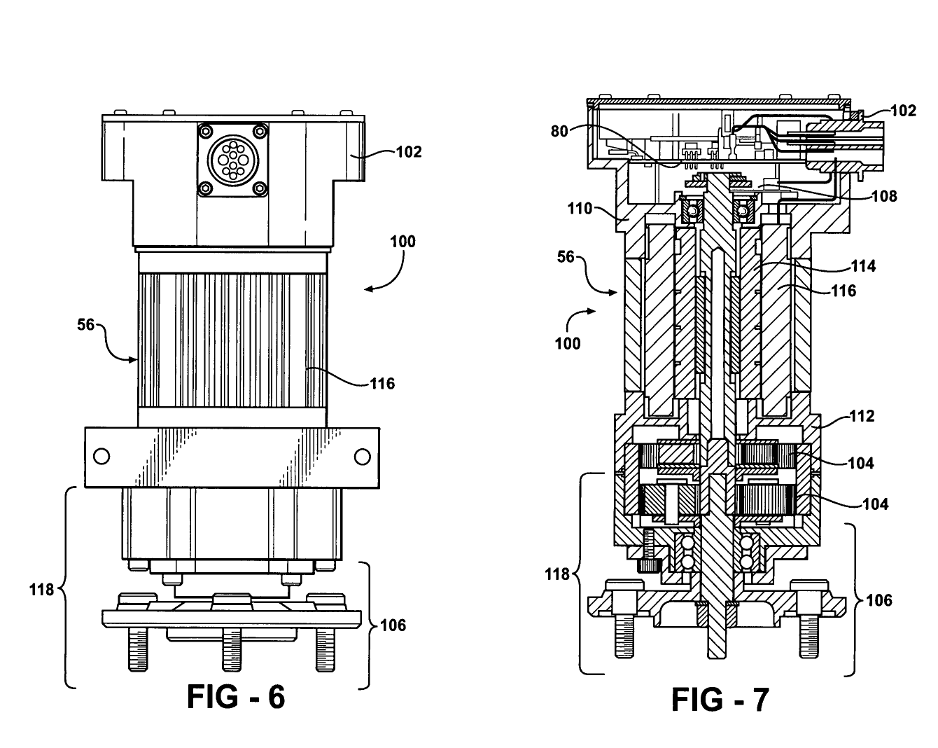

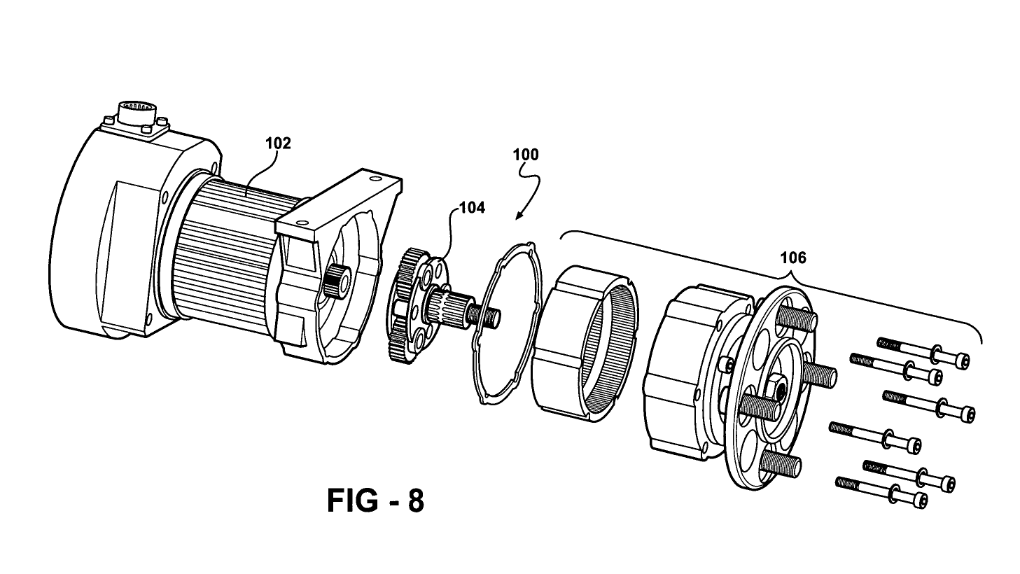

FIG. 6 is a side view of a drive motor assembly 100. The drive motor assembly 100 shown may be for either the first or second drive motors 56, 58. FIG. 7 is a cross-sectional view of the drive motor assembly 100 and FIG. 8 is an exploded view of the drive motor assembly 100. The drive motor assembly 100 includes a drive motor housing 102, a reduction gear assembly 104, and a wheel connector assembly 106. Both of the first and second drive motors 56, 58 and the respective drive motor controllers 78, 82, 84 are disposed in the respective drive motor housings 102. The reduction gear assembly 104, as understood by those of ordinary skill in the art, is used to reduce the relatively high RPM of the electric drive motor to a lower RPM suitable for the drive wheels 34, 36.

The drive motor assemblies 100 are spaced from the main controller 54 such that the main controller 54 communicates with the drive motor controllers 78, 82, 84 via the wiring harness 62. The subject invention provides the vehicle 30 having each of the motors 52, 56, 58, 60 being modular such that if any one of the motors 52, 56, 58, 60 becomes inoperative, any other motor may be substituted in a different motor assembly. The motor controllers 78, 82, 84 drive the motors 52, 56, 58, 60 thereby reducing any maintenance or repair time by being able to switch out one motor for another in a short period of time. Further, the subject invention does not require specialized motors.

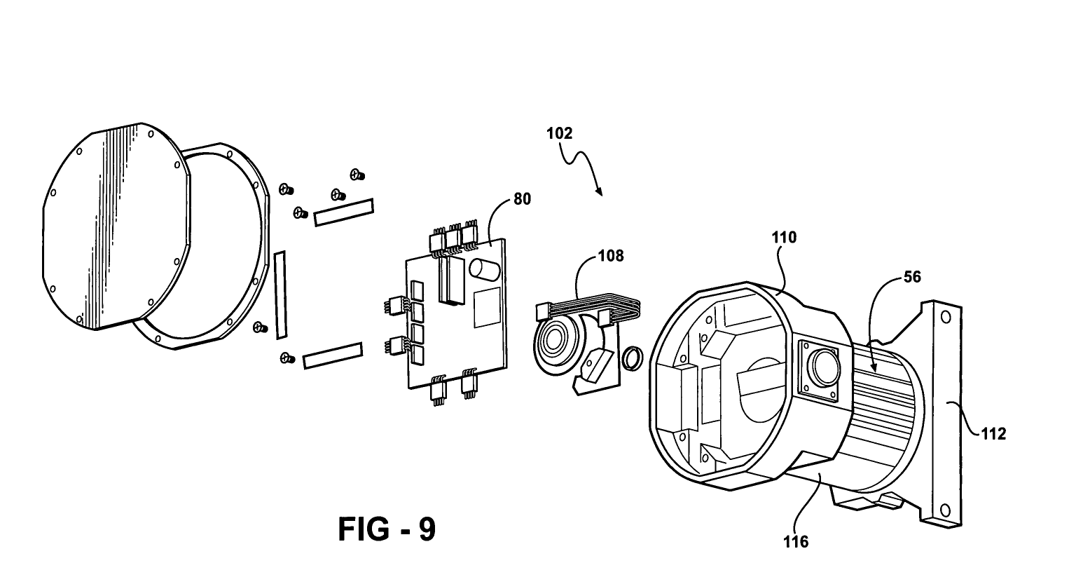

For clarity, the following description is directed toward the first drive motor assembly and it is to be appreciated that the other drive motor assemblies 100 are substantially identical. FIG. 9 is an exploded view of the first drive motor 56 housing. The first drive motor 56 housing includes the first drive motor 56, the first drive motor controller 80, and a drive sensor 108 disposed between the first drive motor 56 and the first drive motor controller 80. The drive sensor 108 senses operation of the first drive motor 56 and is used to determine RPM of the first drive motor 56. The drive sensor 108 may be a Hall effect sensor or an optical sensor. For example, the optical sensor emits a beam of light that is blocked by a rotating disc having an opening to allow the light to pass through. Every rotation of the disc is detected by a light detector detecting the light passing through the disc.

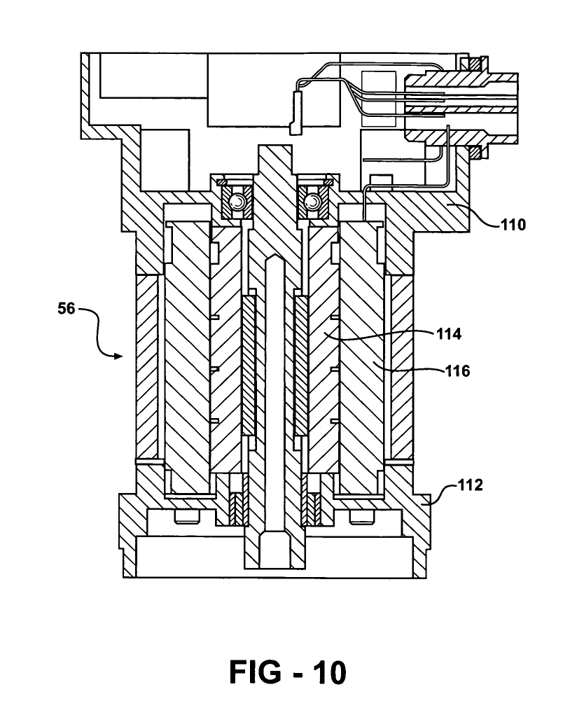

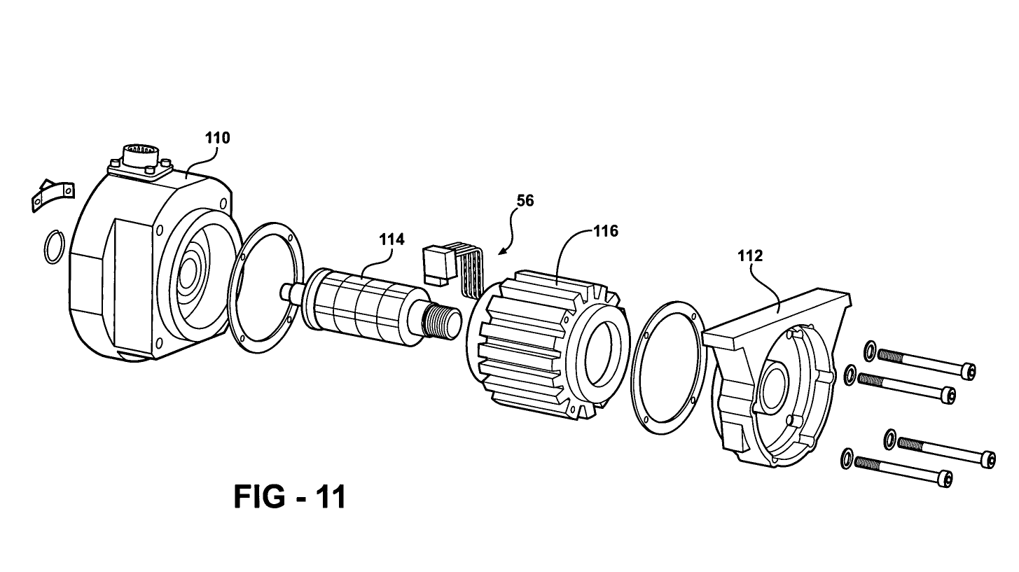

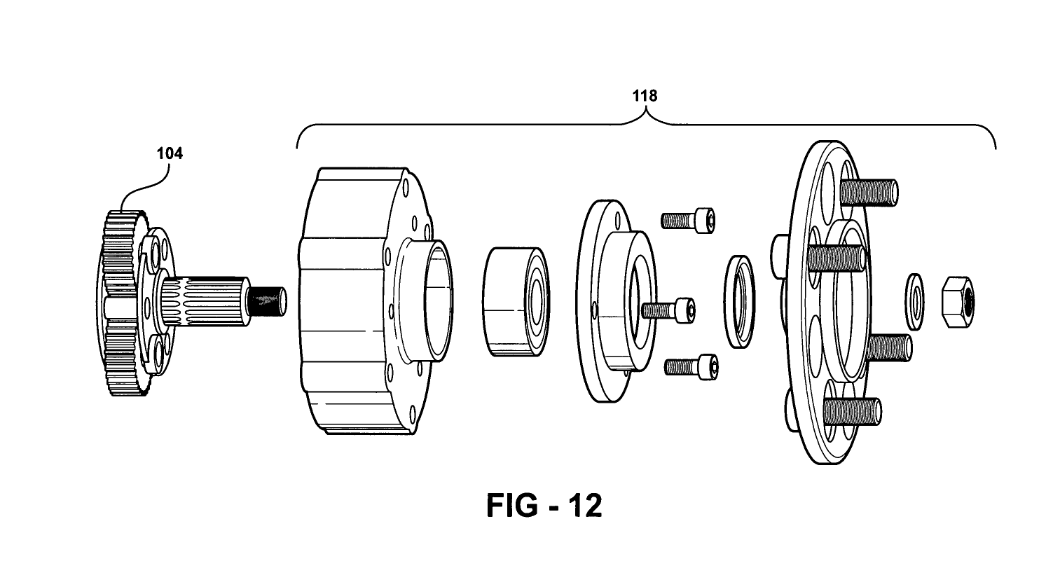

FIG. 10 is a cross-sectional view of the first drive motor 56 and FIG. 11 is an exploded view of the first drive motor 56. The first drive motor 56 includes a main motor housing 110, a motor hub 112, a rotor 114, and a stator 116. As discussed above, each of the motors 52, 56, 58, 60 are preferably brushless motors. The first drive motor controller 80 and drive sensor 108 are housed within the main motor housing 110. FIG. 12 is an exploded view of the wheel connector assembly 106. The wheel connector assembly 106 includes another gear reduction assembly and a drive hub assembly 118. The drive hub assembly 118 connects the drive wheel to the drive motor assembly 100.

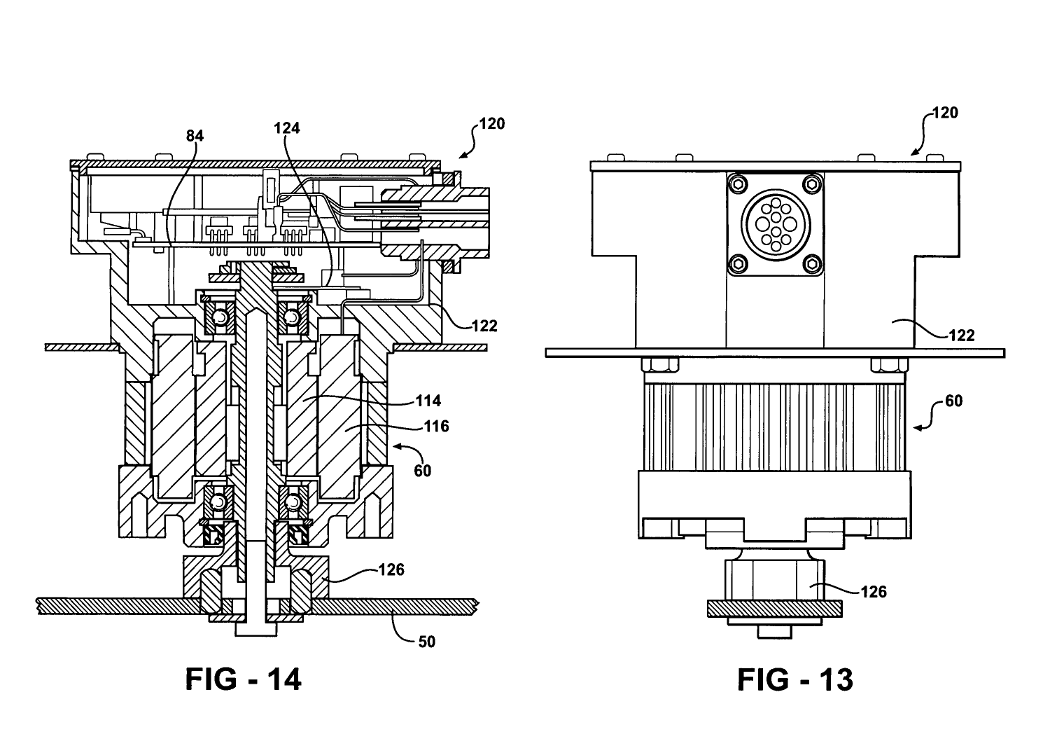

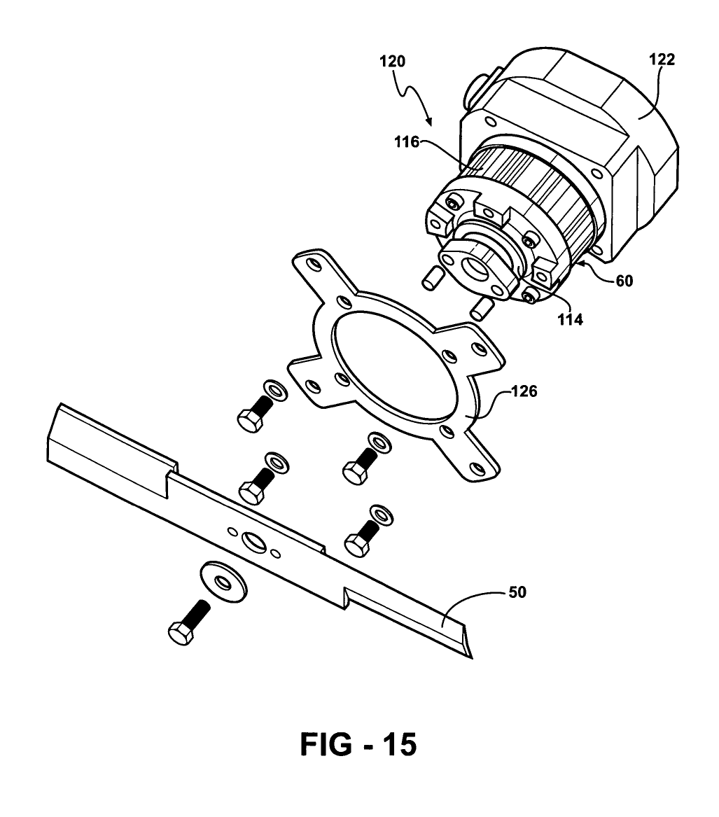

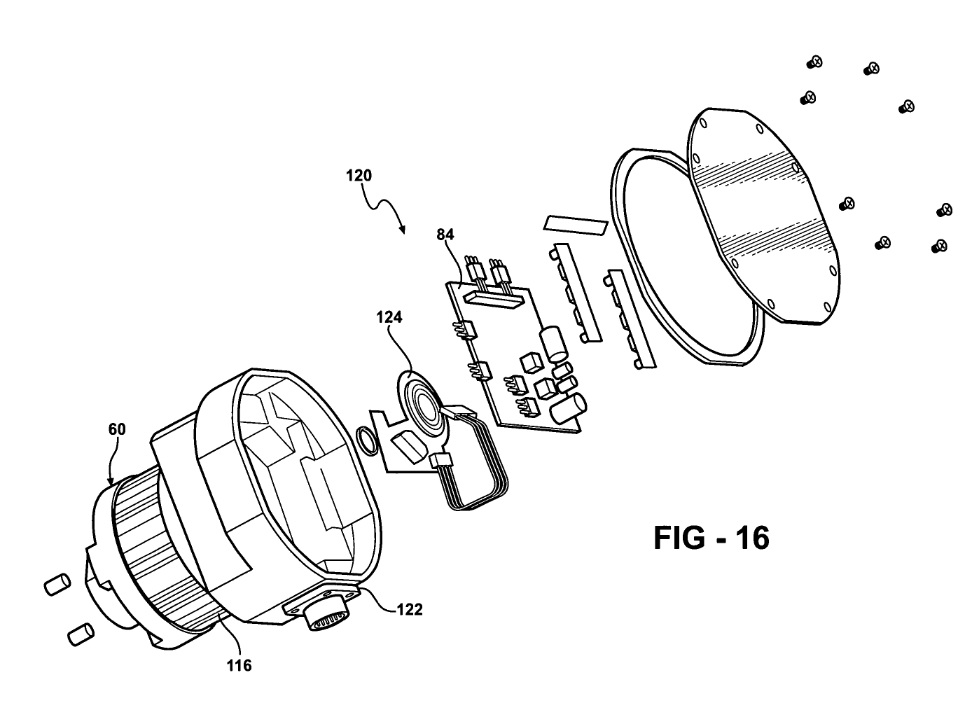

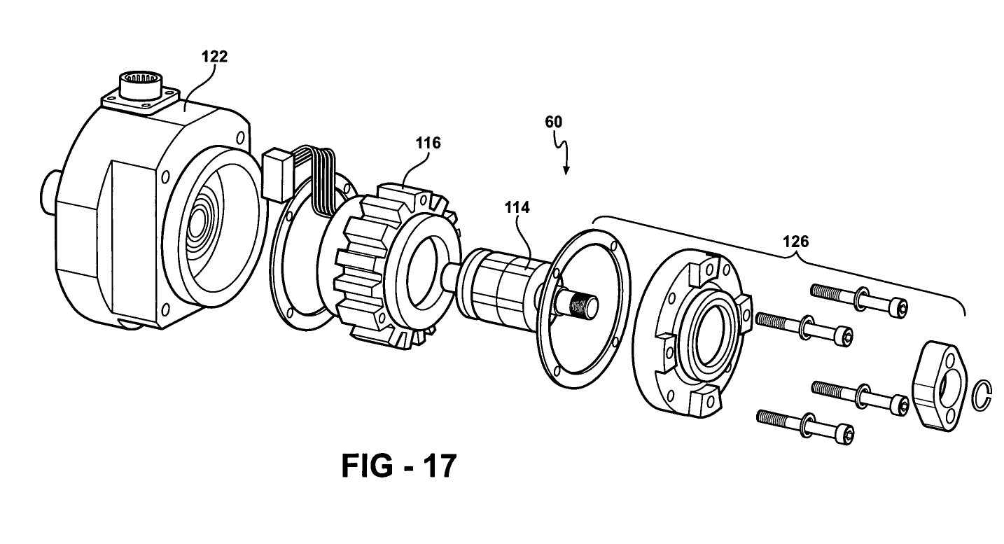

FIG. 13 is a side view of a tool assembly 120 and FIG. 14 is a cross-sectional view of the tool assembly 120. The tool assembly 120 includes a tool housing 122 and the tool 46 mounted thereto as shown in the exploded view of FIG. 15. An exploded view of the tool housing 122 is shown in FIG. 16. The tool housing 122 includes the tool motor 60, the tool motor controller 84 disposed therein, and a tool sensor 124 disposed between the tool motor 60 and the tool motor controller 84. The tool sensor 124 senses operation of the tool motor 60 and is used to determine RPM. The tool sensor 124 may be a Hall effect sensor or an optical sensor, as described above for drive motor assembly 100. The subject invention senses tool, or blade, speed and, when it encounters tall grass, wet grass, or a heavy load, the main controller 54 slows the vehicle 30 down causing the tool motors 60 to operate at the peak of their efficiency curve. This also improves quality of cut because the cutting blades 50 are always cutting through the grass at the correct and optimum speed. FIG. 17 is an exploded view of the tool motor 60 being an electric brushless motor and having the rotor 114 and the stator 116. A tool connector 126 connects to the tool 46 to the tool motor 60.

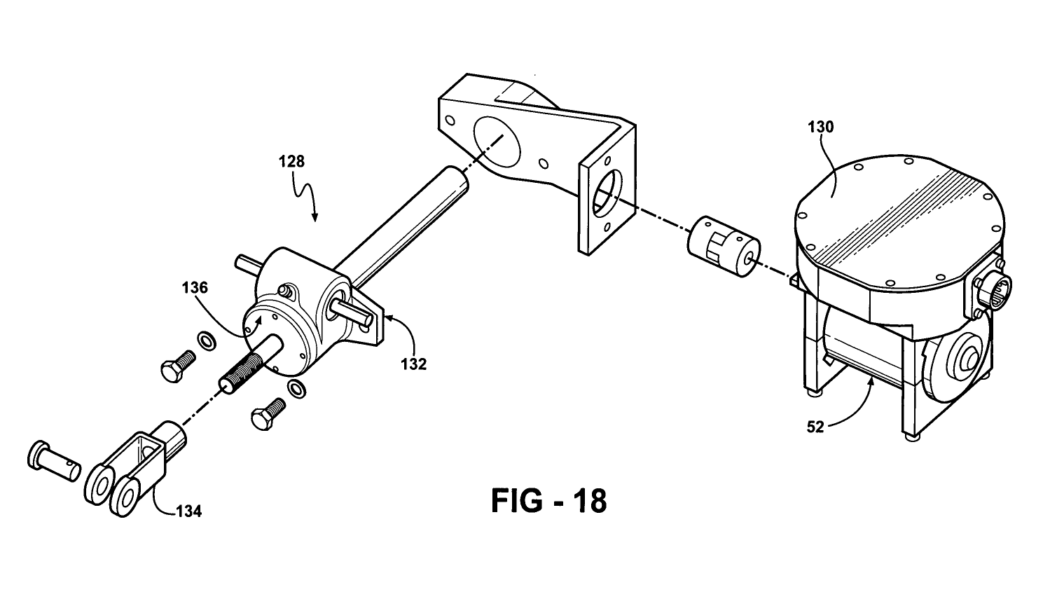

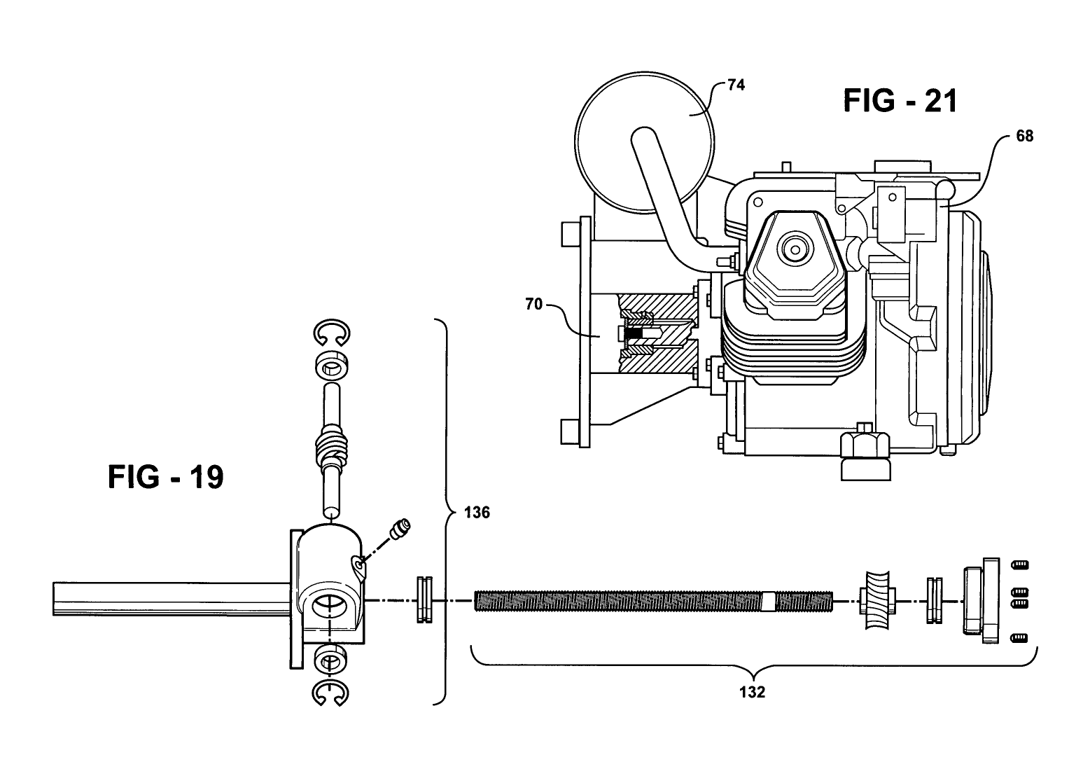

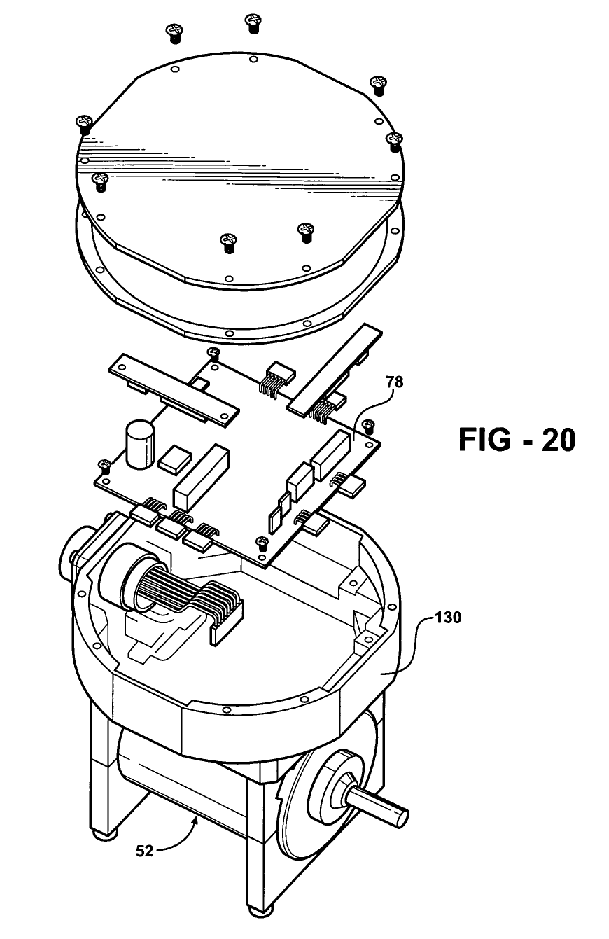

Referring to FIG. 18, a lift assembly 128 is shown and includes a lift motor housing 130 and a lift mechanism 132. The lift mechanism 132 connects the tool 46 to the carriage 32 via a yoke linkage 134. One embodiment of the lift mechanism 132 includes a worm gear assembly 136 shown in FIG. 19. As the lift motor 52 operates, the worm gear assembly 136 raises and lowers the tool 46. FIG. 20 is an exploded view of the lift motor housing 130 having the lift motor 52 and the lift motor controller 78 disposed therein.

The subject invention provides additional advantages such as the vehicle 30 is more energy efficient by a ratio of 3:1 because the vehicle 30 uses small, electric motors 52, 56, 58, 60 that use less power than a gas engine. For example, a 360-watt electric motor (Toro battery powered 18-inch mower) can produce the equivalent cutting power of a 5-Horsepower gas engine, or about 3,700 watts (there are about 740 watts per HP). Therefore, the electric motor is more efficient because gas engines that are used have considerably more power than what is actually required to cut grass. Still another advantage of electric motors 52, 56, 58, 60 is that they can temporarily exceed their rated capacity by drawing more current, whereas the gas engine is limited to its rated capacity. In fact, when the gas engine encounters a situation requiring more power than it can produce, it bogs down and becomes less powerful because it slides off its maximum point on the power curve.

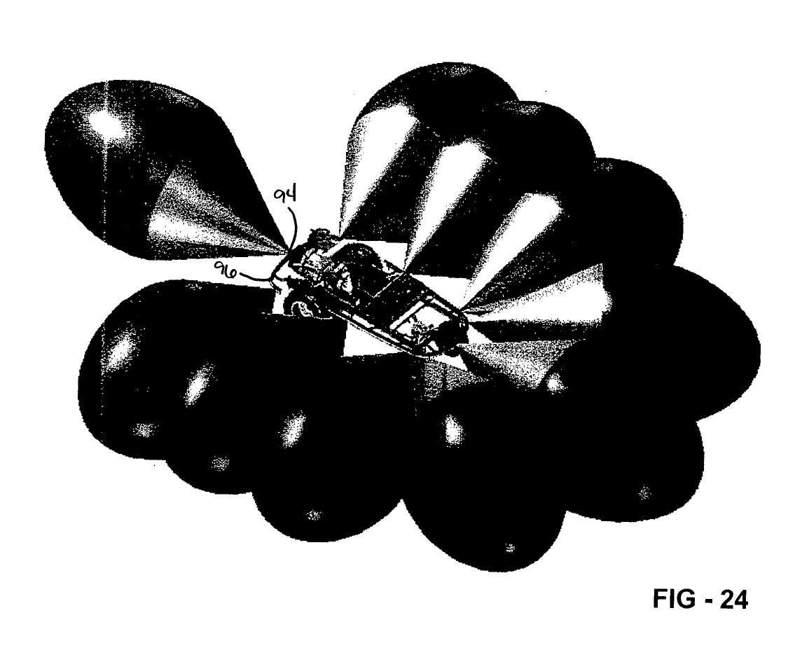

FIG. 24 is a perspective view of the utility vehicle 30 and the area about the vehicle 30 that is monitored by sensors 94. When an object enters into the area monitored by the sensors 94, the control unit orders the utility vehicle 30 to halt. As illustrated in FIG. 24, the area that is detected includes at least 10 sonar sensors 94 mounted at various locations on the frame. These sensors 94 may be 40 kilo-hertz sensors 94 that emit audio signals that bounce off objects encountered and can be adjusted to detect objects from about 2 feet to about 10 feet. The gray portion of the cone represents the area of the total pattern sensed; however, the vehicle 30 senses objects farther out (the blue sections) and at this point, the mower may start to slow down. Further, if the main controller 54 does not receive a signal from one of the sensors 94, the main controller 54 may prevent the utility vehicle 30 from moving and alert an operator.

In some cases, it becomes necessary to ignore signals from the sonar sensors 94. For example, when the mower is mowing next to a wall, the subject invention can be programmed to ignore the wall as an object, allowing the mower to work properly. As the distance gets longer, the practical limitations become more difficult.

Sonar sensors 94 to detect an object or person can go up to 20, 50 or 100 feet or more; however, it is not practical to project any type of sensor more than about 4-6 feet ahead of the utility vehicle 30 due to basic navigation limitations from corners, objects in front such as bushes, uneven terrain, etc. This is true for any type of projected sensing, such as audio, radio frequency, infra-red, etc. so the limiting factor is practical navigation as opposed to other technology.

The subject invention has increased safety relative to commercially available lawn utility vehicles 30. One reason for the increased safety is the subject invention is a mulching utility vehicle 30. The cutting deck is comprised of 3 cutting chambers (38″ utility vehicle 30) or 5 cutting chambers (62″ utility vehicle 30). These chambers surround each blade 50 and they prevent the utility vehicle 30 from throwing rocks, stones, grass, or other objects directly out from the utility vehicle 30. 50,000 people are injured annually from lawn utility vehicles 30 and the most common injury comes from rocks or objects propelled from the utility vehicles 30. In addition, mulching is better for the lawn because nutrients go back into the lawn and it looks better than lawns cut with side discharge; however, it takes more power and good mulching is difficult at high speed. Other advantages of mulching are that it looks better (if done properly), reduces fertilizer and irrigation requirements. Good mulching however is best done with a dedicated mulching deck and slow speed.

Another aspect of the safety is that the blades 50 are relatively short and thin which makes them lighter than ordinary blades 50. It is possible (although not probable) that mulching decks can still throw rocks or objects; however, the objects have to hit the blade 50 at exactly the correct downward angle that causes it to bounce off the ground and continue outward from the utility vehicle 30. This is a very low probability and the object is slowed from the grass it must go through and energy loss from hitting the ground. Small, light blades 50 have much less mass and they impart much less energy into the object which further decreases the probability of an object being propelled from the utility vehicle 30 and less energy results in less speed of the propelled object. As a result, the chances of a problem are dramatically reduced and the utility vehicle 30 is considerably safer than a conventional utility vehicle. The blades 50 with low mass that can be stopped quickly. For example, the blades 50 may be about 13¾ inches long and about 0.187 inches thick.

Another safety feature is the autonomous lawn utility vehicle 30 operates at about 3 MPH for safety reasons. This is ˜4.5 feet per second. If the utility vehicle 30 and blades 50 stop in one second, the utility vehicle 30 will travel ˜4.5 feet before it stops. Sonar sensors 94 project out about 5 feet front, back, and sides. When an object is encountered, the signal bounces off of it and it returns to the sensor. The sonar sensor 94 then sends a signal to the main controller 54 that stops the utility vehicle 30 and blades 50 before someone would touch the utility vehicle 30.

In the subject invention, if it is determined that the utility vehicle 30 and blades 50 need to stop faster, this can be changed relatively easily with slight additional cost. It is not practical to stop the blades 50 in a conventional utility vehicle this fast. For example, if conventional blade 50 drives were used and it took 3 seconds of travel to stop the blades 50 and the audio signals went out 5 feet, the utility vehicle 30 may cause injury to the person before it would stop.

Yet another safety feature is that utility vehicle 30 inertia is reduced by the subject invention. Inertia is a function of mass times velocity squared. The unmanned hybrid utility vehicle 30 weighs about ½ or ⅓ of the weight of a conventional utility vehicle and driver. Therefore, the effective utility vehicle 30 speed is about ½ as fast. As a result, the unmanned utility vehicle 30 has about 1/10th the inertia and is therefore much easier to stop quickly. If a large, conventional utility vehicle were to stop this fast, it may stop the wheels relative to the grass but not necessarily stop the utility vehicle 30 because it may tear the grass and continue moving.

Still another safety feature is that the electronic motor control is much faster than mechanical controls and allows the motors 56, 58, 60 to be stopped quickly. If the drive or cut motors 56, 58, 60 have to be stopped quicker, a back voltage can be applied for very rapid deceleration.

The subject invention also includes a bumper sensor 96 engaging the bumper 38. The bumper sensor 96 is preferably a pressure sensitive strip. In addition to sonar sensors 94 mounted around the utility vehicle 30 as an invisible shield, the bumper sensor 96 as a secondary safety system to further prevent injury. The main controller 54 monitors the sensor 10 times per second to make sure it is working properly.

The subject invention also includes tilt control sensor (not shown) in the possible case where it could turn over. This tilt control sensor sends a signal to the main controller 54. Commercial utility vehicles are now built with roll bars to help protect operators in the case of rollover. The subject invention saves lives because there is no driver. In addition, in some cases, such on the sides of hills next to expressways, drivers sometimes roll over and roll into traffic and are killed. Still yet another safety advantage is that the utility vehicle 30 has a very low center of gravity which tends to prevent rollover and accidents associated with rollover.

Each year, 30-50 people are killed from lawn utility vehicles 30. The most common problem occurs from fathers that take babies (1-3 years old) and have them ride on the utility vehicle with them. They hit an object and the baby falls off and they back up over the baby. The subject invention does not allow the cutting blades 50 to turn when running in reverse as a further safety precaution.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, the reference numerals in the claims are merely for convenience and are not to be read in any way as limiting.

What is claimed is:

1. An unmanned utility vehicle (30) for traversing a plot of land comprising:
a carriage (32) having first and second drive wheels (34, 36) for moving over the plot of land;
a first electric drive motor (56) and a second electric drive motor (58) operatively connected to said first and second drive wheels (34, 36);
a first drive motor controller (80) operatively connected to said first electric drive motor (56) and a second drive motor controller (82) operatively connected to said second electric drive motor (58);
at least one tool (46) supported by said carriage (32) for performing an operation;
at least one electric tool motor (60) engaging said tool (46) and supported by said carriage (32);
a tool motor controller (84) operatively connected to said electric tool motor (60);
a power supply (64) supported by said carriage (32) for powering each of said electric drive motors (56, 58) and said electric tool motor (60);
a main controller (84, 54) for communicating with said drive motor controllers (78, 82, 84) and said tool motor controller (84) to control said electric drive and tool motors (60); and
a plurality of sonar sensors (94) mounted about said carriage (32) for detecting objects and transmitting a signal to said main controller (54) to deactivate or reduce at least one of said electric drive motors (56, 58) and said electric tool motor (60) in response to detecting the object.

2. An unmanned utility vehicle (30) as set forth in claim 1 wherein said electric drive and said tool motors (60) are further defined as brushless electric motors.

3. An unmanned utility vehicle (30) as set forth in claim 1 wherein said tool (46) is further defined as selected from at least one of a mower assembly, a sweeping assembly, a cleaning assembly, and a painting assembly.

4. An unmanned utility vehicle (30) as set forth in claim 1 further comprising a guidance assembly (44) supported by said carriage (32) for communicating with said main controller (54) for guiding said vehicle (30) about the plot.

5. An unmanned utility vehicle (30) as set forth in claim 4 wherein said guidance assembly (44) is further defined as selected from at least one of a laser navigation system, a radio frequency navigation system, a GPS navigation system, and a camera navigation system.

6. An unmanned utility vehicle (30) as set forth in claim 1 further comprising a user interface (90) for programming a route to be followed by said vehicle (30).

7. An unmanned utility vehicle (30) as set forth in claim 6 wherein said user interface (90) and said main controller (54) are further defined as a single, integral unit removable from said carriage (32).

8. An unmanned utility vehicle (30) as set forth in claim 1 further comprising a communication device (98) supported by said carriage (32) and in communication with said main controller (54) for wirelessly transmitting signals from said vehicle (30).

9. An unmanned utility vehicle (30) as set forth in claim 1 further comprising bumper sensors (96) supported by said bumper (38) for transmitting a signal to said main controller (54) in response to contacting an object and deactivating at least one of said electric drive motors (56, 58) and said electric tool motor (60).

10. An autonomous lawn mower comprising:
a carriage (32) having first and second drive wheels (34, 36) for moving over a plot of land;
a guidance assembly (44) supported by said carriage (32) for navigating said lawn mower about the plot;
a first electric drive motor (56) and a second electric drive motor (58) connected to said first and second drive wheels (34, 36);
a first drive motor controller (80) operatively connected to said first electric drive motor (56) and a second drive motor controller (82) operatively connected to said second electric drive motor (58);
at least one mower deck supported by said carriage (32) for performing a mowing operation;
at least one electric mower deck motor engaging said mower deck and supported by said carriage (32);
a mower deck motor controller operatively connected to said electric mower deck motor;
a main controller (54) for communicating with said guidance assembly (44), said drive motor controllers (78, 82, 84), and said mower deck motor controller to control said electric drive and mower deck motors (56, 58, 60);
a plurality of sonar sensors (94) mounted about said carriage (32) for detecting objects and transmitting a signal to said main controller (54) to deactivate or reduce at least one of said electric drive and mower deck motors (56, 58, 60).

11. An autonomous lawn mower as set forth in claim 10 further comprising bumper sensors (96) supported by said bumper (38) for transmitting a signal to said main controller (54) in response to contacting an object and deactivating at least one of said electric drive motors (56, 58) and said electric tool motor (60).

12. An autonomous lawn mower as set forth in claim 10 wherein said guidance assembly (44) is further defined as selected from at least one of a laser navigation system, a radio frequency navigation system, a GPS navigation system, and a camera navigation system.

13. An autonomous lawn mower as set forth in claim 10 further comprising a user interface (90) for programming a route to be followed by said lawn mower.

14. An autonomous lawn mower as set forth in claim 13 wherein said user interface (90) and said main controller (54) are further defined as a single, integral unit removable from said carriage (32).

15. An autonomous lawn mower as set forth in claim 10 further comprising a communication device (98) supported by said carriage (32) and in communication with said main controller (54) for wirelessly transmitting signals from said lawn mower.

16. An autonomous lawn mower as set forth in claim 10 further comprising a controller area network (86) interconnecting said main controller (54), said drive motor controllers (78, 82, 84), and said mower deck motor controller for facilitating communication therebetween to improve operation of said lawn mower.
